(19) United States
(12) Patent Application Publication
(10) Pub. No.: US 2011/0285344 A1
(43) Pub. Date: Nov. 24, 2011

(54) CHARGE DEVICE

(75) Inventors: Chiu-Yuan Lin, TAIPEI CITY (TW); Chien-Pang Hung, TAIPEI CITY (TW); Chih-Chieh Hu, TAIPEI CITY (TW)

(73) Assignee: BEYOND INNOVATION TECHNOLOGY CO., LTD., TAIPEI CITY (TW)

(21) Appl. No.: 13/037,379

(22) Filed: Mar. 1, 2011

(30) Foreign Application Priority Data
May 21, 2010 (TW) 99116313

(51) Int. Cl. H02J 7/00

(52) U.S. Cl. 320/107

(57) ABSTRACT

A charge device includes a charge unit and a voltage detecting circuit. In an operation mode, the charge unit adjusts an output current according to an input voltage to charge a rechargeable device. The voltage detecting circuit generates a feedback voltage according to the value of the output current. In addition, the charge unit further determines an output voltage across the rechargeable device according to the feedback voltage and reduces the output current when the output voltage is less than a first predetermined voltage.

### CROSS-REFERENCE TO RELATED APPLICATION

This application claims the priority benefit of Taiwan application serial no. 99116313, filed on May 21, 2010. The entirety of the above-mentioned patent application is hereby incorporated by reference herein and made a part of this specification.

### BACKGROUND OF THE INVENTION

1. Field of the Invention

The present invention relates to a charge device, and more particularly, to a charge device that reduces its output current when its output voltage is less than a predetermined voltage.

2. Description of Related Art

Following the technology advancement, various types of electronic products trend toward high speed, high performance, light-weight, thin, short and small size. As a result, various portable electronic devices, for example, personal digital assistants (PDA), global positioning systems (GPS), notebook computers, multi-media players, or mobile phones, are gradually becoming the main stream.

Portable electronic devices are usually powered by a rechargeable device and, therefore, the using time of the portable electronic devices is dependent upon the power storage capacity of the rechargeable device. In addition, the rechargeable device must rechargeable device and user's safety. Therefore, the design of the rechargeable device is very important to the application of portable electronic devices.

In practice, the lower the voltage of the rechargeable device is, the higher charge current the existing charge device outputs. However, when the rechargeable device experiences abnormality or malfunction, the voltage of the rechargeable device may also be unduly low. At this time, if the charge device charges the rechargeable device using a large current, charging will not be successful; instead, it may damage the recharge device due to improper heat. Even worse, it can cause an explosion of the rechargeable device. Therefore, safety concerns arise.

### SUMMARY OF THE INVENTION

Accordingly, the present invention is directed to a charge device which reduces its output current when the output voltage is less than a first predetermined voltage, to prolong the lifespan of the rechargeable device.

The present invention provides a charge device adapted for electrically connecting with a rechargeable device. The charge device includes a charge unit and a voltage detecting circuit. The charge unit adjusts an output current according to an input voltage in an operation mode to charge the rechargeable device. The voltage detecting circuit generates a feedback voltage according to the value of the output current. In addition, the charge unit further determines an output voltage across the rechargeable device according to the feedback voltage and reduces the output current when the output voltage is less than a first predetermined voltage.

In one embodiment, the charge unit includes a voltage converting circuit, a current sensing circuit, and a control circuit. The voltage converting circuit is electrically connected to the voltage detecting circuit and adapted to convert a voltage level according to pulse width modulation signal and provide the output current. The current sensing circuit is electrically connected to the voltage converting circuit and adapted to provide a plurality of sensing voltages according to the input voltage. The control circuit is electrically connected with the voltage converting circuit, the current sensing circuit and the voltage detecting circuit, and adapted to determine the value of an input current according to the sensing voltages. When the input current is not greater than a rated current, the control circuit switches to the operation mode to adjust the duty cycle of the pulse width modulation signal according to the input voltage.

In one embodiment, when the input current is greater than the rated current, the charge device stops operation. In addition, when the input voltage is greater than a rated voltage, the control circuit stops operation until the input voltage becomes not greater than the rated voltage.

In one embodiment, the charge device further includes an over-voltage protection circuit. The over-voltage protection circuit is electrically connected to the voltage converting circuit and the control circuit. In addition, the over-voltage protection circuit is adapted to provide a no-load voltage causing the control circuit to decrease the duty cycle of the pulse width modulation signal when the charge device has not been electrically connected with the rechargeable device.

In view of the foregoing, in embodiments of the present invention, the charge unit determines the value of the output voltage according to the feedback voltage generated by the voltage detecting circuit. In addition, when the output voltage is less than a first predetermined voltage, the charge unit decreases the output current. As such, the charge device will not charge the rechargeable device with a large current in the case of low-voltage due to abnormality of the rechargeable device, thereby prolonging the lifespan of the rechargeable device and ensuring the user's safety.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a charge device according one embodiment of the present invention.

FIG. 2 is a circuit diagram of the charge device according to one embodiment of the present invention.

### DESCRIPTION OF THE EMBODIMENTS

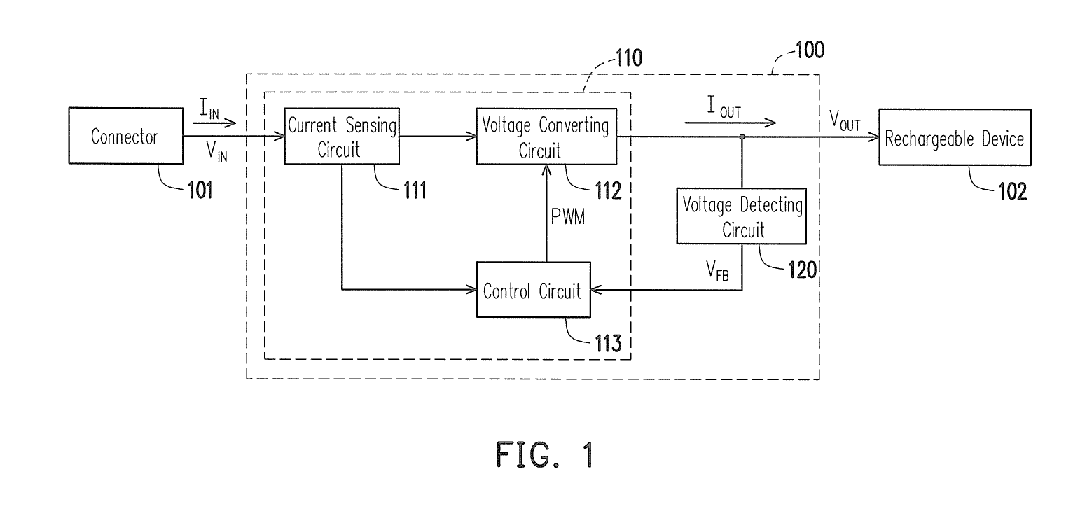

FIG. 1 is a block diagram of a charge device 100 according one embodiment of the present invention, together with a connector 101 and a rechargeable device 102 electrically coupled to the charge device 100. The rechargeable device 102 is, for example, a rechargeable battery. Referring to FIG. 1, the charge device 100 includes a charge unit 110 and a voltage detecting circuit 120. In an operation mode, the charge unit 110 adjusts its output current I_{OUT} according to an input voltage V_{IN} supplied from the connector 101, to charge the rechargeable device 102.

On the other hand, the voltage detection circuit 120 generates a feedback voltage V_{FB} according to an output voltage V_{OUT}. As such, the charge unit 110 can determine the value of the output voltage V_{OUT} across the rechargeable device 102 according to the feedback voltage V_{FB}. In addition, when the output voltage V_{OUT} is less than a first predetermined voltage, the charge unit 110 reduces the output current I_{OUT}. When the output voltage V_{OUT} is greater than a second predetermined voltage, the charge unit 110 clamps the output voltage V_{OUT}.

Here, the first predetermined voltage acts as a low-voltage protection point. That is, when the output voltage V_{OUT} decreases to this first predetermined voltage, it indicates that the output voltage V_{OUT} is too low, which may be caused by abnormality or malfunction of the rechargeable device 102. Therefore, to avoid the large-current charging due to low-voltage abnormality of the rechargeable device 102, the charge unit 110 reduces the output current I_{OUT} when the low-voltage abnormality occurs. In addition, when the output voltage V_{OUT} returns to the first predetermined voltage, the charge unit 110 restores to the operation mode. Besides, the second predetermined voltage acts as a high-voltage protection point, such that, when the output voltage V_{OUT} increases to the second predetermined voltage, the charge unit 110 clamps the output voltage V_{OUT} to prevent the output voltage V_{OUT} from rising beyond this maximum value.

Specifically, the charge unit 110 includes a current sensing circuit 111, a voltage converting circuit 112, and a control circuit 113. The voltage transforming unit 112 is electrically connected to the voltage detecting circuit 120. The current sensing circuit 111 is electrically connected with the voltage converting circuit 112. The control circuit 113 is electrically connected to the voltage converting circuit 112, the current sensing circuit 111 and the voltage detecting circuit 120. The voltage converting circuit 112 receives an input voltage V_{IN} through the current sensing circuit 111 and converts the voltage level according to a pulse width modulation signal PWM to provide the output current I_{OUT} to charge the rechargeable device 102. The voltage converting circuit 112 is, but not limited to, a DC to DC converter.

On the other hand, the current sensing circuit 111 provides a plurality of sensing voltages to the control circuit 113 according to the input voltage V_{IN}, and the current sensing circuit 111 also provides a plurality of sensing currents to the control circuit 113 according to the input current I_{IN}. The reference voltage is obtained by the current sensing circuit 111 and pin 1 of the pulse width modulation controller U21 of the control circuit 113, while the reference current is obtained by the current sensing circuit 111 and pin 2 and pin 3 of the pulse width modulation controller U21 of the control circuit 113. As such, the control circuit 113 can determine the value of the input current I_{IN} flowing through the connector 101 according to the sensing currents. For example, if the connector 101 is a universal serial bus (USB) connector, it specifies a max current of 500 mA. Therefore, in order to comply with the upper current limit of the connector 101, the control circuit 113 compares the input current I_{IN} against a rated current (e.g. 500 mA).

If the input current I_{IN} is not greater than the rated circuit, it indicates that the input current I_{IN} is within the range acceptable by the connector 101. Therefore, the control circuit 113 switches to the operation mode. In the operation mode, the control circuit 113 adjusts the duty cycle of the PWM signal according to the input voltage V_{IN}. In addition, if the input current I_{IN} is greater than the rated current, it indicates that the input current I_{IN} goes beyond the scope that the connector 101 can operate on and, therefore, the charge device 100 stops operation.

In addition, in the operation mode, the control circuit 113 also determines the value of the input voltage V_{IN}. When the input voltage V_{IN} is greater than a rated voltage, the control circuit 113 stops operation until the input voltage V_{IN} becomes not greater than the rated voltage. This is mainly because an unduly high input voltage V_{IN} causes an unduly high output current I_{OUT}. Therefore, at this time, the control circuit 113 must close the PWM signal until the input voltage V_{IN} decreases to the rated voltage.

On the other hand, the control circuit 113 further determines the output voltage V_{OUT} according to the feedback voltage V_{FB}. Therefore, when the output voltage V_{OUT} is greater than the second predetermined voltage or less than the first predetermined voltage, i.e. the output voltage V_{OUT} is greater than the high-voltage protection point or less than the low-voltage protection point, the control circuit 113 adjusts the duty cycle of the PWM signal to avoid the large current due to unduly high output voltage V_{OUT} or low-voltage abnormality.

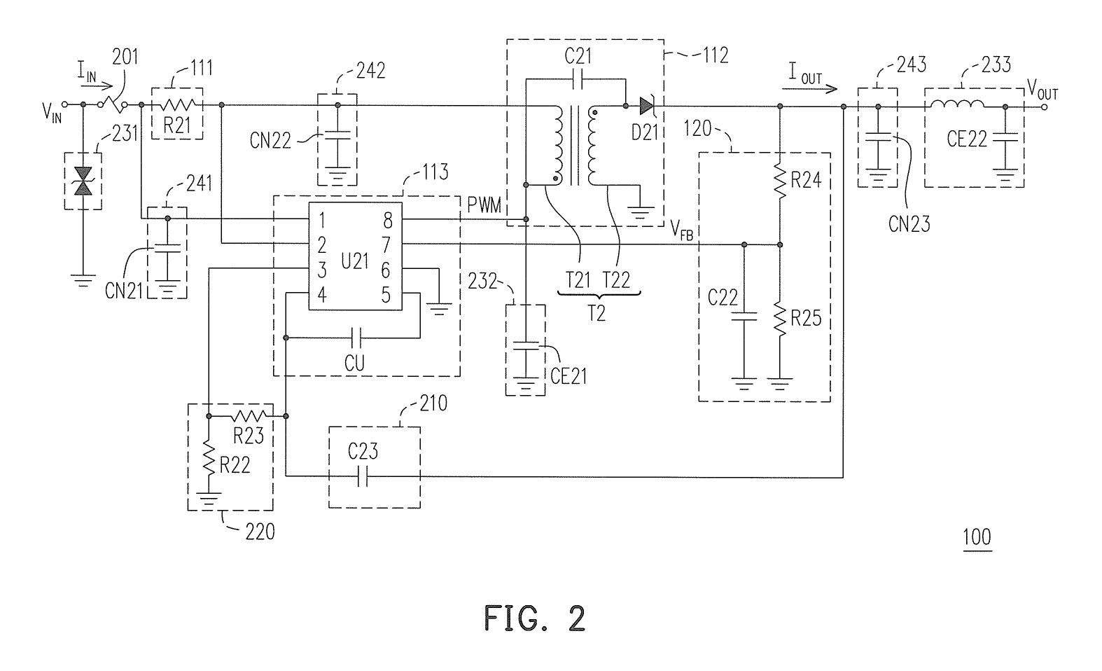

FIG. 2 is a circuit diagram of the charge device according to one embodiment of the present invention, in which the detailed circuit of each circuit block of the charge device 100 is shown. The current sensing circuit 111 receives the input voltage V_{IN} through a fuse 201 and the current sensing circuit 111 includes a resistor R21. A first end of the resistor R21 is used to receive the input voltage V_{IN}, and a second end of the resistor R21 is electrically connected with the voltage converting circuit 112 and the control circuit 113.

The voltage converting circuit 112 is described herein as a DC converter and therefore it includes a transformer T2, a capacitor C21, and a Schottky diode D21. A first end of the primary coil T21 of the transformer T2 is electrically connected to the current sensing circuit 111, and a second end of the primary coil T21 is electrically connected with the control circuit 113. A first end of the secondary coil T22 of the transformer T2 is electrically connected with the anode of the Schottky diode D21, and a second end of the secondary coil T22 is electrically connected to ground. The cathode of the Schottky diode D21 is used to provide the output current IOUT. A first end of the capacitor C21 is electrically connected to the second end of the primary coil T21, and a second end of the capacitor C21 is electrically connected to the first end of the secondary coil T22.

The control circuit 113 includes a PWM controller U21 and a capacitor CU. The PWM controller U21 has pins 1 to 8. Pin 4 and pin 5 are electrically connected to each other through the capacitor CU to compensate for the internal circuit of the PWM controller U21. In addition, pin 1 and pin 2 of the PWM controller U21 are used to receive the sensing voltage from the current sensing circuit 111. As such, the PWM controller U21 can calculate the voltage across the resistor R21 and hence calculate the value of the input current I_{IN}. In addition, pin 6 of the PWM controller U21 is electrically connected to ground. Pin 7 of the PWM controller U21 is used to receive the feedback voltage VFB from the voltage detecting circuit 120, and pin 8 is used to output the PWM signal.

As shown in FIG. 2, the charge device 100 further includes a current adjustment circuit 220 which includes a resistor R22 and a resistor R23. A first end of the resistor R22 is electrically connected with pin 3 of the PWM controller U21, and a second end of the resistor R22 is electrically connected to ground. A first end of the resistor R23 is electrically connected to the first end of the resistor R22, and a second end of the resistor R23 is electrically connected with pin 4 of the PWM controller U21. In practice, the PWM controller U21 provides, via its pin 4, voltage to the current adjustment circuit 220 to set the value of the rated current using the resistor R22.

Specifically, the voltage detecting circuit 120 includes a resistor R24, a resistor R25, and a capacitor C22. A first end of the resistor R24 is electrically connected with the voltage converting circuit 112, and a second end of the resistor R24 is electrically connected to the control circuit 113. A first end of the resistor R25 is electrically connected with the second end of the resistor R24, and a second end of the resistor R25 is electrically connected to ground. A first end of the capacitor C22 is electrically connected to a second end of the resistor R24, and a second end of the capacitor C22 is electrically connected to ground. Here, the voltage drop of the output voltage V_{OUT} on the resistor R24 and the resistor R25 as a result of voltage dividing forms the feedback voltage V_{FB}.

As shown in FIG. 2, in general, when the charge device 100 has not been electrically connected with the rechargeable device 102, i.e. when the system is in a no-load state, the feedback of the input current I_{IN} is rather low. At this time, the control circuit 113 switches the duty cycle of the PWM signal to a maximum value, causing the voltage converting circuit 112 to generate a unduly high output voltage V_{OUT}. In order to avoid this situation, in one embodiment, the charge device 100 further includes an over-voltage protection circuit 210 having a capacitor C23.

A first end of the capacitor C23 is electrically connected to the voltage converting circuit 112, and a second end of the capacitor C23 is electrically connected to the control circuit 113. The capacitor C23 is used to increase the response speed so as to timely clamp the output voltage V_{OUT}. In operation, when the system is in a no-load state, the over-voltage protection circuit 210 immediately feeds back a no-load voltage. As such, the control circuit 113 decreases the duty cycle of the PWM signal according to the no-load voltage, thereby avoiding the unduly high output voltage V_{OUT}.

On the other hand, in order to eliminate electromagnetic interference (EMI), the charge device 100 further includes a plurality of noise filters 241 to 243 and a plurality of EMI filters 231 to 233. The noise filter 241 is electrically connected between the current sensing circuit 111 and the control circuit 113, the noise filter 242 is electrically connected between the current sensing circuit 111 and the voltage converting circuit 112, and the noise filter 243 is electrically connected to the output end of the voltage converting circuit 112. In addition, the noise filters 241 to 243 are formed by capacitors CN21 to CN23, respectively. The capacitor CN23 may be an equivalent capacitor, i.e. a combination of other different capacitors equivalent to the capacitor CN23 in capacitance can be used.

In addition, the EMI filter 231 is formed by a transient voltage suppression (TVS) diode. As such, the TVS diode can protect the charge device 100 against electrostatic discharge (ESD) and EMI purge. Besides, the EMI filter 232 is formed by a capacitor CE21 and electrically connected between the voltage converting circuit 112 and the control circuit 113. The EMI filter 233 is electrically connected to the output end of the voltage converting circuit 112 and includes an inductor LE21 and a capacitor CE22. A first end of the inductor LE21 is electrically connected to the voltage converting circuit 112, a first end of the capacitor CE22 is electrically connected to a second end of the inductor LE21, and a second end of the capacitor CE22 is electrically connected to ground.

In summary, in embodiments of the present invention, the voltage detecting circuit generates a feedback voltage to enable the charge unit to determine the value of the output voltage. In addition, when the output voltage is less than a first predetermined voltage, the charge unit decreases the output current. As such, the charge device will not charge the rechargeable device with a large current in the case of low-voltage due to abnormality of the rechargeable device, thereby prolonging the lifespan of the rechargeable device and ensuring the user's safety.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A charge device adapted for electrically connecting with a rechargeable device, the charge device comprising:
a charge unit adapted to adjust an output current according to an input voltage in an operation mode to charge the rechargeable device; and
a voltage detecting circuit adapted to generate a feedback voltage according to the value of the output current, wherein the charge unit further determines an output voltage across the rechargeable device according to the feedback voltage and reduces the output current when the output voltage is less than a first predetermined voltage.

2. The charge device according to claim 1, wherein when the output voltage is greater than a second predetermined voltage, the charge unit clamps the output voltage.

3. The charge device according to claim 1, wherein the charge unit comprises:
a voltage converting circuit electrically connected to the voltage detecting circuit and adapted to convert a voltage level according to a pulse width modulation signal and provide the output current;
a current sensing circuit electrically connected to the voltage converting circuit and adapted to provide a plurality of sensing voltages according to the input voltage; and
a control circuit electrically connected with the voltage converting circuit, the current sensing circuit and the voltage detecting circuit, and adapted to determine a value of an input current according to the sensing voltages, wherein when the input current is not greater than a rated current, the control circuit switches to the operation mode to adjust the duty cycle of the pulse width modulation signal according to the input voltage.

4. The charge device according to claim 3, wherein when the input current is greater than the rated current, the charge device stops operation.

5. The charge device according to claim 3, wherein when the input voltage is greater than a rated voltage, the control circuit stops operation until the input voltage becomes not greater than the rated voltage.

6. The charge device according to claim 3, wherein the control circuit further determines the value of output voltage according to the feedback voltage and adjusts the duty cycle of the pulse width modulation signal when the output voltage is greater than the second predetermined voltage or less than the first predetermined voltage.

7. The charge device according to claim 3, wherein the voltage converting circuit comprises:
a transformer having a primary coil and a secondary coil, wherein a first end of the primary coil is electrically connected to the current sensing circuit, a second end of the primary coil is electrically connected to the control circuit, and a second end of the secondary coil is electrically connected to ground;
a first capacitor, wherein a first end of the first capacitor is electrically connected to the second end of the primary coil, and a second end of the first capacitor is electrically connected to a first end of the secondary coil; and
a Schottky diode, wherein an anode of the Schottky diode is electrically connected to the first end of the secondary coil, and a cathode of the Schottky diode is adapted to provide the output current.

8. The charge device according to claim 3, wherein the current sensing circuit comprises a first resistor, a first end of the first resistor is adapted to receive the input voltage, and a second end of the first resistor is electrically connected to the voltage converting circuit and the control circuit.

9. The charge device according to claim 3, further comprising a current adjustment circuit electrically connected with the control circuit to set the value of the rated current.

10. The charge device according to claim 9, wherein the current adjustment circuit comprises:
a second resistor, wherein a first end of the second resistor is electrically connected with the control circuit, and a second end of the second resistor is electrically connected to ground; and
a third resistor, wherein a first end of the third resistor is electrically connected with the first end of the second resistor, and a second end of the third resistor is electrically connected to the control circuit.

11. The charge device according to claim 3, wherein the voltage detecting circuit comprises:
a fourth resistor, wherein a first end of the fourth resistor is electrically connected with the voltage converting circuit, and a second end of the fourth resistor is electrically connected with the control circuit;
a fifth resistor, wherein a first end of the fifth resistor is electrically connected with the second end of the fourth resistor, and a second end of the fifth resistor is electrically connected to ground; and
a second capacitor, wherein a first end of the second capacitor is electrically connected with the second end of the fourth resistor, and a second end of the second capacitor is electrically connected to ground.

12. The charge device according to claim 3, further comprising an over-voltage protection circuit electrically connected to the voltage converting circuit and the control circuit, wherein the over-voltage protection circuit is adapted to provide a no-load voltage causing the control circuit to decrease the duty cycle of the pulse width modulation signal when the charge device has not been electrically connected with the rechargeable device.

13. The charge device according to claim 12, wherein the over-voltage protection circuit comprises a third capacitor, a first end of the third capacitor is electrically connected to the voltage converting circuit, and a second end of the third capacitor is electrically connected to the control circuit.

14. The charge device according to claim 3, further comprising a first noise filter electrically connected between the current sensing circuit and the control circuit.

15. The charge device according to claim 3, further comprising a second noise filter electrically connected between the current sensing circuit and the voltage converting circuit.

16. The charge device according to claim 3, further comprising a third noise filter electrically connected to the voltage converting circuit.

17. The charge device according to claim 3, further comprising a first electromagnetic interference filter electrically connected between the voltage converting circuit and the control circuit.

18. The charge device according to claim 3, further comprising a second electromagnetic interference filter electrically connected to the voltage converting circuit.

19. The charge device according to claim 1, wherein the rechargeable device is a rechargeable battery.
